(19) United States
(12) Patent Application Publication
(10) Pub. No.: US 2008/0125100 A1
(43) Pub. Date: May 29, 2008

(54) MOBILE DEVICE OUTBOUND PERSONALITY PORTABILITY

(75) Inventors: Paul Harrington, Naperville, IL (US); Leon Tong, Naperville, IL (US); Bill Noll, Bristol, IL (US)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: WESTELL TECHNOLOGIES, INC., Aurora, IL (US)

(21) Appl. No.: 11/563,789

(22) Filed: Nov. 28, 2006

(51) Int. Cl. H04M 3/42

(52) U.S. Cl. 455/415

(57) ABSTRACT

An embodiment of the present invention includes a method to provide a calling number identifier for a non-mobile telephone associated with a mobile identification number. The method includes placing a telephone call from a non-mobile telephone, processing the telephone call placed by the non-mobile telephone, wherein processing the telephone call includes selectively associating a calling number identifier for the non-mobile telephone with a mobile identification number, and transmitting the mobile identification number as the calling number identifier to a called party.

### FIELD OF THE INVENTION

The present invention relates in general to data communication and in particular to a method and system for communicating information specific to a mobile device to a non-cellular network for use on outbound calls placed over the non-cellular network.

### BACKGROUND OF THE INVENTION

Most consumers place calls from both a mobile device over cellular networks and devices over non-cellular networks, such as public switch telephone networks. In some instances, the consumer will use the mobile device for work and the non-mobile device for their residence. Or, when the consumer is at work the consumer will switch between the two devices throughout the day. With more and more consumers working from home or placing work related calls from non-cellular devices, there is a need to be able to identify the outbound call from the non-mobile devices as being placed from the mobile device. There are many reasons for such a need. For example, the intended recipient of the call may only recognize the mobile device incoming caller ID and therefore may not even answer an incoming call from the non-cellular device. In addition, if the consumer is working from home, the consumer may not want to release its residence caller ID.

A method, system, and apparatus are needed to allow the non-mobile device to behave like the outbound call was placed from the mobile device. In fact, this problem can be generalized to providing access to all mobile device “personality” features from a non-mobile device on a per-call basis. These “personality” traits include but aren't limited to phone book, address book, Instant Messaging profile/buddy list, ring tone, and default screen.

### SUMMARY OF THE INVENTION

In accordance with the present invention there is provided in one embodiment a method, system, and apparatus to allow a non-mobile device attached to a non-mobile network, to assume the identity and behavior of a mobile device. The embodiment thus allows a mobile subscriber to make transactions (such as text messages, video calls or SMS messages) from a fixed location (home, business, public phone) using a non-mobile device, and convey to the called party that the call is originating from the “network identity” assigned to the mobile device. (Network identity may include but is not limited to being a MIN [mobile identification number] SIP URL, or an IM identity). This will further allow a business person to make such transactions from a cordless phone within their residence, but the called party will receive the caller ID of the originator's mobile device.

In one embodiment of the present invention a method to provide a calling number identifier for a non-mobile telephone associated with a network identity (such as MIN, SIP URL, or an IM identity) is provided. The method includes the steps of placing a transaction from a non-mobile telephone; processing the transaction placed by the non-mobile telephone, wherein processing the transaction includes selectively associating a calling number identifier for the non-mobile telephone with the network identity and transmitting the network identity as the calling number identifier to a called party.

In another embodiment, the method includes extracting the network identity from a corresponding mobile device and loading the network identity for accessibility from the non-mobile telephone.

In another embodiment, the method includes extracting personality information from the mobile device and loading the personality information for accessibility from the non-mobile telephone.

In yet another embodiment, a method to provide personality information associated with a mobile device to a non-mobile device is provided. The method includes extracting personality information associated with a mobile device from the mobile device; loading the personality information into a storage medium; and providing access to the storage medium and to the personality information from a non-mobile device.

In another embodiment, the method includes providing a network identity associated to the mobile device with the personality information, such that processing a transaction placed by the non-mobile device includes selectively associating a calling number identifier for the non-mobile device with the network identity whereby the network identity is transmitted to a called party as the calling number identifier.

In another embodiment, the method includes providing a abbreviated address number (such as a speed dial number, or other address number) associated to the mobile device with the personality information, wherein processing a transaction placed by the non-mobile device includes selectively associating a telephone number or network identity corresponding to the abbreviated address number, when the abbreviated address number is used with the non-mobile device whereby the telephone number or network identity is utilized by the non-mobile telephone when the abbreviated address number is dialed.

In another embodiment, the method includes providing access to the personality information from a non-mobile device by authenticating a user access to the personality information. Such steps of authenticating user access may includes entering a security code into the non-mobile device and checking the entered security code against a pre-defined security code, wherein access to the personality information is permitted when the entered security code matches the pre-defined security code.

In another embodiment, the method includes extracting personality information associated with a mobile device from the mobile device by automatically extracting the personality information from the mobile device when the mobile device enters a predefined service area providing a local network for the mobile device and the non-mobile device.

In another embodiment, the method includes providing a fixed mobile convergence service area communication system which provides services for the mobile device and the non-mobile device. In such communication systems the steps of extracting and loading are performed when the mobile device is within the fixed mobile convergence service area communication system.

In another embodiment of the present invention, a system to provide personality information associated with a mobile device to a non-mobile device is provided. The system may include an arbitrator coupled to the non-mobile device in a communications network and positioned within a fixed mobile convergence service area. The arbitrator is typically configured to communicate with the mobile device when the mobile device enters the service area. A storage medium is provided and is coupled to the. arbitrator and accessible by the non-mobile device. The personality information associated with a mobile device is loaded onto the storage medium when the mobile device enters the service area. The personality information is then made accessible from the non-mobile device.

In another embodiment, the system includes a mobile device number provided in the personality information associated with the mobile device, and when the non-mobile device is used to place a telephone call over the communications network, the mobile device number is selectively associated to a calling number identifier for the non-mobile device such that the mobile device number is transmitted over the communications network as the calling number identifier.

In another embodiment, the system includes a network identity provided in the personality information associated with the mobile device, and when the non-mobile device is used to place a transaction over the communications network, the network identity number is selectively associated to a calling number identifier for the non-mobile device such that the network identity is transmitted over the communications network as the calling number identifier.

In another embodiment, the system includes an address book provided in the personality information associated with the mobile device; the address book includes at least one telephone number (or device IP address for example), such that when the non- mobile device is used to place a telephone call over the communications network, access to the address book is provided from the non-mobile device.

In another embodiment, the system includes an abbreviated address number provided in the personality information associated with the mobile device; the abbreviated address number is associated to a telephone number. When the non-mobile device is used to place a telephone call over the communications network, access to the abbreviated address number is selectively provided from the non-mobile device such that the telephone number is dialed from the non-mobile device when the abbreviated address number is selected.

In another embodiment, the system includes an arbitrator that authenticates access to the personality information. And may include storing a pre-defined security code and comparing the pre-defined security code against a code entered on the non-mobile device.

In another embodiment, the system includes an arbitrator that extracts the personality information from the mobile device and includes the ability to load the extracted personality information onto the storage medium.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a block diagram including elements of a communication network suitable for practicing an embodiment of the present invention; and

FIG. 2 is a block flow diagram of a process than can be used to practice an embodiment of the present invention.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

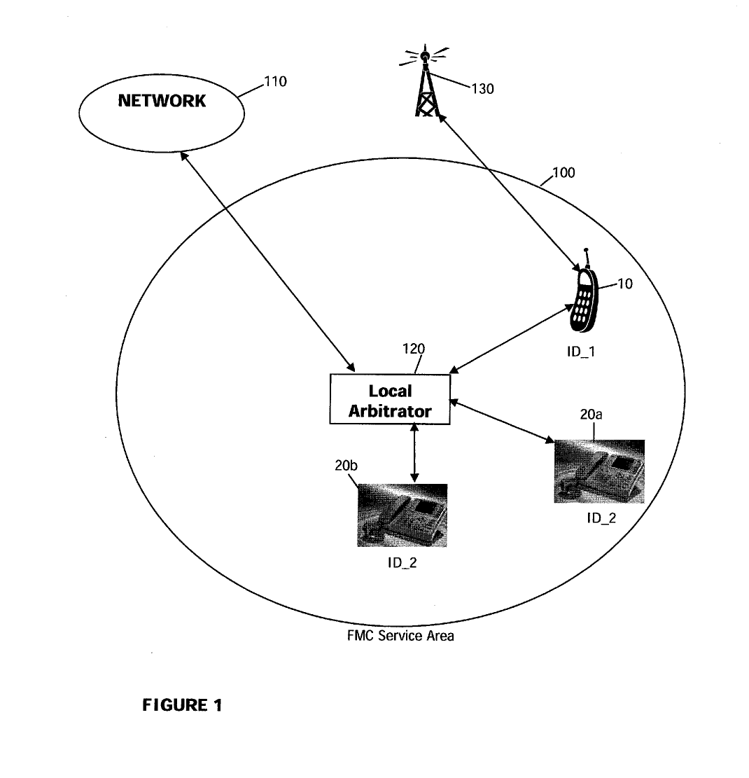

Referring now to FIG. 1, there is illustrated in accordance to one embodiment of the present invention a fixed mobile convergence (FMC) service area 100, which is available to provide a mobile device 10 with an alternative cellular/mobile connection over an alternative network 110, such as but not limited to a WiFi or WiMax access point. This is due in part because the presence of the mobile device 10 is detected by the alternative network, which for a number of known reasons, will route calls to the mobile device 10 over the alternative network 110 such that incoming calls may be may be answered by any non-mobile device 20 that are also connected to the alternative network 110. However, when a transaction (such as an outbound call, text message, video call, or SMS message) is placed from a non-mobile handset 20a or 20b, the outbound call will not have the network identify (such as the MIN, IP address, IM identity, or SIP URL) associated with the mobile handset (ID_1) but will have the Caller ID associated with the non-mobile handsets (ID_2).

In the present invention, examples of mobile devices include dual-mode cellular phones (cellular mode, plus some other LAN technology like Bluetooth or WiFi), and dual-mode PDAs. The FMC service area includes the physical space where a LAN technology provides an alternative service access network to the traditional mobile access network. Through any one of a number of existing mechanisms, the network 110 and a local arbitrator 120 associate the mobile device 10 with the local arbitrator 120 instead of cellular access portion of the mobile network 130.

Examples of these existing mechanisms which will associate the mobile device 10 to the local network 110 are: 1) the mobile device 10 initiates connectivity with the local arbitrator 120 (examples are cellular 2G, 2.5G, 3G, WiFi, WiMax, or Bluetooth); 2) the local arbitrator 120 initiates connectivity (an example is RFID); or 3) the mobile network 130 uses geographic information comparing the coordinates of the mobile device 10 with the known coordinates of the FMC service area 100.

Once connection is established between the mobile device 10 and the local network 11.0, the personality information of the mobile device 10 is extracted from the mobile device 10 and a copy of the personality information is inserted or loaded into the local arbitrator 120. This may be accomplished in the following manner. After the local network 110, local arbitrator 120, and mobile device 10 concur that access of the mobile device 10 is switching from the mobile network 130 to the FMC service area 100, the local network 110 elicits a data upload of the personality information stored on the mobile device 10. (This type of upload technique is already supported by CDMA mobile operators as a means for users to back up their stored data.). This upload includes a network identity such as the mobile device number (MIN), and includes the mobile device address book, and any other personality information contained in the mobile device 10.

As an alternative implementation, the local arbitrator 120 may upload the information out of the mobile device 10 into the local arbitrator 120. (The local network 110 isn't the only entity that can initiate and receive the contents of personality information upload. Further, the final destination of this information is the local arbitrator 120 not the network 110 or any entity within the network).

If an external network arbitrator (external to the FMC Service Area 100) is used to upload the personality information from the mobile device 10 then the external network arbitrator downloads the personality information of the mobile device 10 to the local arbitrator 120 where the information is stored on a database (not shown) in the local arbitrator 120. Obviously, this step could be skipped if the local arbitrator 120 initiated and received the upload request. The external network arbitrator passes information back to the local arbitrator 120 that the mobile device's primary network has been temporarily switched from the mobile network 130 to the local network 110. Again this step could be skipped if the local arbitrator 120 initiated and received the upload request.

Other methods by which the local arbitrator 120 may discover or obtain the personality information from mobile device 10, including but not limited to the mobile device number, include:

(a) If WPA is used as a WiFi security mode, a type of EAP authentication may be employed in which the mobile device passes its mobile device number to the local arbitrator 120, which then relays it to an authentication server for authentication. Once authenticated, the local arbitrator 120 retains the mobile device number, which it can then use to pass on to a local non-mobile device 20.

(b) If WEP or WPA-PSK are used for WiFi security, the WEP key or pre-shared key, respectively, may be used as an index into a pre-configured database table that maps these keys to a mobile device number.

(c) Regardless of the type of WiFi security mode used, the local arbitrator 120 may employ a pre-configured database table that maps the MAC identifier of the mobile device to the mobile device number. When the mobile device 10 associates with the local arbitrator 120, it passes the MAC ID to the local arbitrator 120, which then infers the mobile device number based on the MAC ID.

(d) The local arbitrator 120 may employ a docking cradle for the mobile device 10. When the mobile device 10 is inserted into the docking cradle, the local arbitrator 120 extracts the mobile device number through a protocol exchange with the mobile device 10. For GSM mobile devices, the docking cradle may embody a SIM card reader, for example).

In any event, the local arbitrator 120 will track the different possible device IDs that are associated or loaded therein. The device ID could be a MIN, phone number, an email address, an IP address, a physical layer address, or some combination of these. The list of device IDs is usually non-zero: minimally the list contains the device ID(s) of the local arbitrator itself. In FIG. 1, non-mobile devices 20a and 20b are devices that aren't part of the mobile network, but communicate on the local network 110. Initially the device ID list could contain the telephone number(s) assigned to the local access area (i.e. a user's home phone number, illustrated as ID_2). This initial telephone number should be the number that is the default number of the local phone(s). This should also be the phone number to be used if emergency services are requested (e.g. 911 is dialed).

In accordance to the present invention, the calling party wants to make an transaction, such as outbound call, video call, text message or SMS message, from one of the non-mobile devices 20a (that is defaulted to a caller identification number ID_2) but desires to have the caller ID, that is sent out through the local network 110 associated or set to the network identity of the mobile device (ID_1). Using the non-mobile device 20a the user selects the network identity of the mobile device (ID_1) from a list that is displayed on the non-mobile device 20a. One representation of this list is a scrolling list, and this list is the home display of the device 20a.

It is important to clarify that this list is stored locally in the local arbitrator 120 (customer premises equipment). Queries are not being initiated to the local or wireless networks, there also aren't any triggers being presented to the networks, nor is there any network database. As far as the local network 110 is concerned, a VoIP call is being originated from a certain (non-fixed) IP address to a given destination. There isn't any special network processing that is occurring. Also once the user selects the ID from the list, the “personality” associated with that ID is sent from the local arbitrator 120 to the non-mobile device 20a. This includes features such as the address/phone book associated with the mobile device 10. In other words, the caller can use its mobile device's personality to dial the destination phone number, such as selecting the destination phone number from a scrolling list on the non-mobile device 20a just as if they were using their mobile device. Again there is no network interaction to accomplish this—it is all performed by the local arbitrator 120.

The non-mobile device 20a communicates with the local arbitrator 120 over a logical communication channel, informing the local arbitrator 120 that a user wishes to initiate an action using the network identity of the mobile device 10. An optional capability is to allow a security code to be entered before a network identity can be committed to a new physical device. In this case the local arbitrator 120 requests that the user enter a key sequence on non-mobile device 20a, the non-mobile device sends that sequence to the local arbitrator 120 which validates it against the known valid security key for that network identity. For positive matches, the transaction flow will continue. For negative matches the user is given some type of error treatment (re-enter or cancel).

The local arbitrator 120 also may support the user request, and uses the ID_1 in next set of transactions with the network, even though the service request is being initiated from the non-mobile device 20a.

Once the service involving the non-mobile device 20a is complete, the network identity of the mobile device is dis-associated with the non-mobile device 20a, and the display on non-mobile device 20a returns to the available device ID list. Again, this aids future emergency services calls.

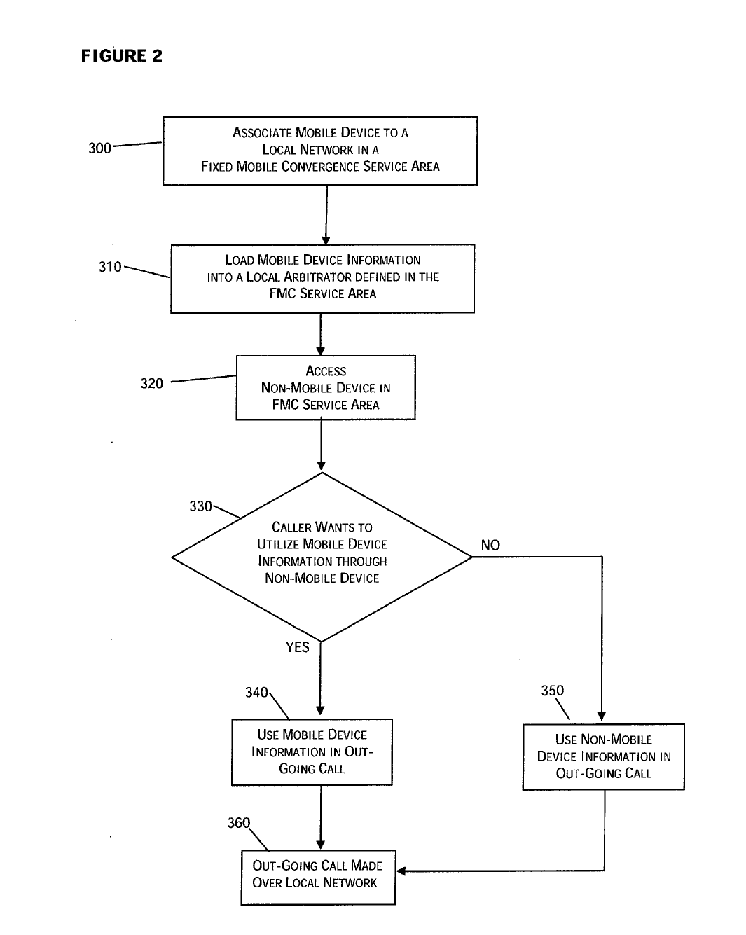

FIG. 2 is a block diagram illustrating how the system shown in FIG. 1 may operate. When a mobile device enters a Fixed Mobile Convergence Service Area, the mobile device becomes associated to the local network, Box 300. Information or data from the mobile device is then loaded into a local arbitrator that is defined in the FMC service area and which facilitates communication between the mobile/non-mobile devices to and with the local network, Box 310. A caller wishing to make a transaction (such as an outgoing call, text message, video call or SMS message) from a non-mobile device within the FMC service area accesses the non-mobile device, Box 320. Next, the caller decides whether they want to utilize the mobile device information through the non-mobile device, Box 330. If the caller wants to use the non-mobile device information, Box 350, the transaction is processed normally, Box 360. However, when the caller wants the non-mobile transaction to use the information of the mobile device, the local arbitrator will associate the non-mobile device to the information of the mobile device, Box 340. The transaction made by the non-mobile device is then made over the local network with the associated information of the mobile device, Box 360. For example, the caller id received by the called party will indicate the MIN. Alternatively, the stored address book, abbreviated address numbers (such as speed dial numbers, or other numbers that may initiate an SMS), and/or other personality information from the mobile device will be accessible from the non-mobile device.

Although various embodiments are specifically illustrated and described herein, it will be appreciated that modifications and variations of the present invention are covered by the above teachings and within the purview of the appended claims without departing from the spirit and intended scope of the invention.

We claim:

1. A method to provide a calling party identifier for a non-mobile device associated with a mobile device, comprising:
placing a transaction from a non-mobile device;
processing the transaction placed by the non-mobile device, wherein processing the transaction includes selectively associating a calling party identifier for the non- mobile device with the mobile device number; and
transmitting the mobile device number as the calling party identifier to a called party.

2. The method of claim 1 further comprising extracting the mobile device number from a corresponding mobile device.

3. The method of claim 2 further comprising extracting personality information from said mobile device and loading said personality information for accessibility from said non-mobile device.

4. The method of claim 1, wherein the transaction is a telephone call.

5. The method of claim 1, wherein the transaction is a text message.

6. The method of claim 1, wherein the transaction is a SMS message.

7. A method to provide personality information associated with a mobile device to a non-mobile device, comprising:
extracting personality information associated with a mobile device from said mobile device;
loading said personality information into a storage medium; and
providing access to said storage medium and to said personality information from a non-mobile device.

8. The method of claim 7 further comprising:
providing a mobile device number associated to said mobile device with said personality information, such that processing a transaction placed by the non-mobile device includes selectively associating a calling number identifier for the non-mobile device with the mobile device number whereby the mobile device number is transmitted to a called party as the calling number identifier.

9. The method of claim 8, wherein said transaction is a telephone call.

10. The method of claim 7 further comprising:
providing an abbreviated address number associated to said mobile device with said personality information, wherein processing a transaction placed by the non-mobile device includes selectively associating a number corresponding to said abbreviated address number, when said abbreviated address number is used with said non-mobile device whereby the number is utilized by said non-mobile telephone when said abbreviated address number is used.

11. The method of claim 10, wherein said transaction is a telephone call.

12. The method of claim 10, wherein said transaction is a text message.

13. The method of claim 10, wherein the number is a telephone number.

14. The method of claim 10, wherein the number is a SMS number.

15. The method of claim 7, wherein the step of providing access to said personality information from a non-mobile device includes a step of authenticating access to said personality information.

16. The method of claim 15, wherein authenticating a user access includes entering a security code into the non-mobile device and checking said entered security code against a pre-defined security code, wherein access to said personality information is authenticated when said entered security code matches said pre-defined security code.

17. The method of claim 7, wherein the step of extracting personality information associated with a mobile device from said mobile device includes automatically extracting said personality information from said mobile device when said mobile device enters a predefined service area providing a local network communication system for said mobile device and said non-mobile device.

18. The method of claim 7, wherein the mobile device and the non-mobile device are part of a fixed mobile convergence service area communication system.

19. The method of claim 18, wherein the steps of extracting and loading are performed when the mobile device is within said fixed mobile convergence service area communication system.

20. A system to provide personality information associated with a mobile device to a non-mobile device, comprising:
an arbitrator coupled to the non-mobile device in a communications network and positioned within a fixed mobile convergence service area, said arbitrator configured to communicate with the mobile device when said mobile device enters said service area;
a storage medium coupled to said arbitrator and accessible by said non-mobile device;
means for loading personality information associated with a mobile device onto said storage medium when said mobile device enters said service area;
means for accessing said personality information from the non-mobile device.

21. The system of claim 20 further comprising a mobile device number provided in said personality information associated with said mobile device, and when the non- mobile device is used to place a transaction over said communications network, means for selectively associating said mobile device number to a calling number identifier for the non-mobile device such that the mobile device number is transmitted over said communications network as the calling number identifier.

22. The system of claim 21, wherein the transaction is a telephone call.

23. The system of claim 21, wherein the transaction is a text message.

24. The system of claim 21, wherein the transaction is a video call.

25. The system of claim 20 further comprising an address book provided in said personality information associated with said mobile device, said address book including at least network identity, such that when the non-mobile device is used to place a transaction over said communications network, means for providing access to said address book from said non-mobile device.

26. The system of claim 25, wherein the transaction is a telephone call.

27. The system of claim 25, wherein the transaction is a text message.

28. The system of claim 25, wherein the transaction is a SMS message.

29. The system of claim 26, wherein the transaction is a video call.

30. The system of claim 20 further comprising an abbreviated address number provided in said personality information associated with said mobile device, said abbreviated address number being associated to a telephone number, wherein when the non-mobile device is used to place a telephone call over said communications network, means for selectively providing access to said abbreviated address number from said non- mobile device such that said telephone number is dialed from said non-mobile device when said abbreviated address number is selected.

31. The system of claim 20, wherein said arbitrator further comprising means for authenticating access to said personality information.

32. The system of claim 31, wherein means for authenticating access includes storing a pre-defined security code and comparing said pre-defined security code against a code entered on said non-mobile device.

33. The system of claim 20, wherein the arbitrator includes means for extracting said personality information from said mobile device and includes said means for loading said extracted personality information onto said storage medium.
